(19) United States
(12) Patent Application Publication
(10) Pub. No.: US 2004/0031683 A1
(43) Pub. Date: Feb. 19, 2004

(54) Method for separating and detecting proteins by means of electrophoresis

(76) Inventors: Heinz Eipel, Bensheim (DE); Markus Hammermann, Heidelberg (DE); Herbert Platsch, Mannheim (DE); Gerhard Weber, Kirchheim (DE)

Correspondence Address: KEIL & WEINKAUF, 1350 CONNECTICUT AVENUE, N.W., WASHINGTON, DC, 20036, US

(21) Appl. No.: 10/416,460

(22) PCT Filed: Nov. 15, 2001
(86) PCT No.: PCT/EP01/13195

(30) Foreign Application Priority Data
Nov. 16, 2000 (DE) 10056838.6
Apr. 27, 2001 (DE) 10120803.0
Jul. 20, 2001 (DE) 10135497.5

(51) Int. Cl. G01N 27/26

(52) U.S. Cl. 204/450

(57) ABSTRACT

The invention relates to a method for fractionating and detecting proteins or protein samples of cellular origin, the proteins being contained in a separation buffer solution and the following process steps being performed:

the protein samples are split into individual fractions in a first separation step in accordance with free-flow electrophoresis or isoelectric focusing (IEF) or isotachophoresis and are linked to a label,

in a second separation step, the protein fractions are fractionated in one or more capillaries in accordance with capillary electrophoresis, and at least one label, linked to the protein fractions, is detected in said one capillary or said several capillaries.

The invention relates to a method for separating and detecting proteins in order to expediate proteome analysis.

Proteome denotes all proteins of an organism, a cell, an organelle or a body fluid, detected and quantified under exactly defined conditions and at a defined time. In proteome analysis, proteins are studied to see which proteins play which role in biological processes and which proteins are particularly important in interacting with other proteins. Within the scope of proteome analysis, the question as to what extent chemicals, active substances and other external factors (environmental factors, heat, cold, water shortage, pH, etc.) influence cellular protein expression is also investigated. Furthermore, in toxicology and pharmacology proteome analysis is used for trying to find out which proteins in which protein constellations are responsible for which side effects. Finally, the question as to whether protein expression of microorganisms can be influenced such that space-time yields of fermentative production processes can be improved is investigated.

For technical reasons—concerning both separation and detection—complete quantitative observation and evaluation of all proteins of a proteome has not been possible up until now; hydrophobic proteins, proteins of extreme size, whether they are particularly large or particularly small, strongly acidic or strongly basic, create serious problems for separating such proteins so that complete proteomes cannot be detected, even under otherwise optimal conditions. At present it is assumed that considerably more than 50% of all expressed proteins can be recorded quantitatively.

In view of the enormous number of expressed proteins, sample preparation represents a considerable problem. The sample preparation phase sets the course for separating and identifying even complex protein patterns.

It has turned out that solubility considerably influences the fractionation of proteins. Proteins readily dissolving in water usually cause no problems with respect to fractionation ability.

Proteins which have stable secondary or tertiary structures and are difficult to dissolve in water are stabilized with respect to their solubility behavior by adding chaotropic substances such as, for example, guanidine hydrochloride or urea. However, this can lead to unwanted reactions of individual proteins, and this causes a protein originally present in one form to turn into a plurality of forms and thus extends the heterogeneity of the sample already present.

Membrane proteins, whose natural environment is lipid membranes and which, during their isolation from each other, tend to immediately agglomerate again and become insoluble again, are particularly difficult to handle. These hydrophobic proteins can be kept in a soluble state only if detergents are added, but these frequently interfere with subsequent protein fractionation stages.

Although high protein concentrations are highly desirable for most fractionation methods and evaluation procedures, they are accompanied by a risk of aggregates being formed. In contrast, low protein concentrations which have a positive effect on solubility behavior involve additional preparation steps prior to the actual separation.

The present fractionation techniques for the range of the molecular mass of proteins are firstly electrophoresis and secondly chromatography. However, neither of these two techniques of protein fractionation is alone capable of separating substantially more than 100 different components. However, since a simple cell usually contains several thousand different protein species and since the amount of proteins contained in a sample may differ by a factor of 10⁶, a sufficiently large separation capacity has to be provided which can only be created by coupled multidimensional fractionation methods.

Proteins have zwitterion character and, accordingly, can have a positive or negative charge. Electrophoresis methods can be used to separate individual components according to their mobility in the electric field. The electrophoretic mobility of each protein is a characteristic parameter. For proteome analysis, two electrophoresis methods are used, isoelectric focusing (IEF) and sodium dodecyl sulfate polyacrylamide gel electrophoresis (SDS PAGE).

In isoelectric focusing, the individual proteins on the gel move within a pH gradient to their particular isoelectric point where their net charge is balanced and thus they lose their electrophoretic mobility. If a protein, owing to thermal diffusion effects, moves out of the pH range corresponding to the isoelectric charge, then it takes up a charge again and moves in the electric field back to the position in the pH gradient which corresponds to its isoelectric point.

The SDS PAGE method provides for all proteins to be loaded with sodium dodecyl sulfate (=SDS); the negative SDS-protein complexes move in the electric field in the direction of the anode and can be separated in the polyacrylamide matrix according to their molecular sizes.

A combination of the IEF method and the SDS PAGE method led to 2D gel electrophoresis (2D PAGE) according to Klose and O'Farrell 1975 (J. Biol. Chem. 1975, 250, 4007 to 4020; Humangenetik 1975, 25, 231 to 245).

This method provides for a separation of proteins in the first dimension using isoelectric focusing according to their isoelectric point. As a second dimension, sodium dodecyl sulfate polyacrylamide gel electrophoresis is carried out for fractionating the proteins according to their size. To date, this method represents the only procedure capable of fractionating complex protein mixtures with high resolution. The advantages of the 2D PAGE method are the two separation principles complementary to each other, namely the IEF method and the SDS PAGE method, according to charge and molecular weight. This technique can be used in principle for all proteins. The resolution potential of this method can be increased markedly by using narrow pH gradients in the isoelectric focusing (“zoom gels”).

On the other hand, this method also has disadvantages; thus, some experience and skill are required for sample preparation. The amount applied is limited, so that weakly expressed proteins cannot be detected directly. Protein transfer from the first to the second dimension is difficult and hard to reproduce. There is no simple automation possibility for this method. Likewise, not all of the proteins are detected by this method. For molecular weights of less than 10,000 and for molecular weights of greater than 100,000, no satisfactory and meaningful results are obtained. After separation in the gel, the proteins still have to be stained in a complicated manner.

Staining is carried out, for example, using dyes such as Coomassie Blue, using colloidal silver or zinc/imidazole, or using fluorophores such as Sypro® Ruby, Sypro® Orange or Sypro® Red. All staining methods used have in common the fact that binding between proteins and staining reagent is not covalent but is based on ionic, hydrophobic or van-der-Waals interactions. Following the staining, the gels are usually digitized with the aid of a scanner or fluorescence scanner.

U.S. Pat. No. 6,043,025 and U.S. Pat. No. 6,127,134 describe a method and a kit which can detect differences in two or more protein samples. The protein extracts of different samples are covalently labeled with various, positively charged fluorophores, combined and subjected to 2D PAGE. Identical proteins from the different samples may then be detected and quantified in the same gel based on their different fluorescence wavelengths. According to the solution disclosed in U.S. Pat. No. 6,127,134, the proteins of a first cell are prepared by means of known treatment techniques, with the first cell coming from a first group of cells. The proteins are covalently labeled with a first chromophore from a pair of chromophores. This is followed by preparing by means of known treatment techniques a second cell which has been taken from a second group of cells. The proteins of said second cell are covalently labeled with a second chromophore.

As an alternative to said staining methods, radioactive methods may also be employed. For this purpose, the cells are mixed with particular isotope-labeled compounds such as, for example, ³⁵S cysteine or ³²PO₄³⁻. Following 2D PAGE, a Phosphorimager is commonly used in these cases for digitization. Using image analysis programs such as, for example, MELANIE, PDQUEST, IMAGEMASTER or Z3, the protein spots in the digitized gels obtained are subsequently detected, quantified and classified. Detecting the individual spots and matching the spots between the individual gels is very time-consuming and requires manual intervention by the operator.

The whole procedure starting from electrophoresis to staining, detection and quantification in accordance with the 2D PAGE method is very complicated.

It is an object of the present invention, in view of the technical problems outlined, to develop a separation method for proteins which reduces the use of gels, can be carried out quickly and simply and can be automated and allows simple quantification of the fractionated proteins.

We have found that this object is achieved by a method for fractionating and detecting proteins, the protein samples being contained in a separation buffer solution and the following process steps being performed:

by means of isoelectric focusing (IEF) or isotachophoresis, the protein samples are split into individual fractions in a first separation step in accordance with free-flow electrophoresis and are linked to a label;

in a second separation step, the protein fractions are fractionated in one or more capillaries in accordance with capillary electrophoresis, and at least one label is detected in the individual capillary/capillaries.

The advantages of the method proposed according to the invention are primarily that it is now possible to carry out fractionation of proteins or cellular proteins with the possibility of automation simultaneously for a plurality of samples. This makes it possible to considerably increase the sample throughput. In addition, the present complicated labor-intensive image analysis can be dispensed with by use of the method proposed according to the invention. In addition, the amount of sample to be applied can be considerably reduced. Suitable labeling methods such as fluorescence labeling can considerably increase sensitivity and thus the resolution potential with respect to detecting weakly expressed proteins.

In an advantageous embodiment of the method proposed according to the invention, the protein fractions obtained after the first separation step are linked to a reactive fluorophore. This may be carried out, for example, by coupling the N-hydroxysuccinimide esters (NHS esters) or isothiocyanates of fluorophores to free amino groups of the proteins. Preferably, free amino groups of the N termini or of lysines are selected as coupling sites. In contrast to fluorescence staining in a polyacrylamide gel, the chromophores may be bound covalently to the individual proteins in the method proposed according to the invention.

In an advantageous embodiment of the method proposed according to the invention, protein fractions obtained after the first separation step are admixed with a label. This may be carried out, for example, by adding a fluorophore, for example Sypro® Ruby, Sypro® Orange or Sypro® Red. The fluorophores Sypro® Ruby, Sypro® Orange or Sypro® Red may be bound adsorptively, for example by hydrophobic, ionic or van-der-Waals forces.

In a second separation step, capillaries may be employed which either are provided with a polyacrylamide gel or which do not contain said substance, i.e. which are empty. Detection of the individual proteins is carried out in the second separation step using laser-induced fluorescence. The sensitive fluorescence detection ensures a large dynamic range and high sensitivity.

In order to improve the migration behavior of proteins in the capillary electrophoresis, sodium dodecyl sulfate may be added to the separation buffer. The high separation capability of capillary electrophoresis produces a substantially better resolution in the second dimension in comparison with the 2D-PAGE gel method; furthermore, the high automatability of both separation steps, FFE and capillary electrophoresis, allows a substantially higher throughput and thus a better statistical validation of the results obtained. In order to ensure parallel processing of a relatively large number of protein samples after free-flow electrophoresis, all wells of a microtiter plate can be detected and quantified in parallel and separately by the same number of capillaries. This can be achieved, for example, by using a commercial apparatus for DNA sequencing.

In the second separation step, a plurality of various fluorophores can advantageously be detected simultaneously in each capillary. This makes it also possible to separate simultaneously in one capillary a plurality of protein samples labeled with different fluorophores. This facilitates combining protein samples from different experimental conditions, after the FFE-IEF method and fluorescence labeling, and fractionating said samples in a single capillary electrophoresis run. The previously necessary matching of the individual spots in the individual gels is dispensed with.

Sensitive fluorescence detection ensures a wide dynamic range and high sensitivity. High separation efficiency of capillary electrophoresis achieves substantially better resolution in the second dimension compared with the 2D PAGE gel method. Owing to the high automation possibility of both separation steps, FFE and capillary electrophoresis, substantially higher turnover and thus better statistical validation of the measured results is expected.

Fractionation of the protein samples in the first separation step may advantageously be carried out, for example, in a microtiter plate, using a microtiter plate whose number of wells corresponds to the number of separated protein fractions. The number of capillaries employed in the second separation step in accordance with capillary electrophoresis corresponds advantageously to the number of sample fractions introduced into the microtiter plate.

The method proposed according to the invention, which is carried out in two separation steps by utilizing free-flow electrophoresis and capillary electrophoresis, is to be described in the following in more detail while specifying the components used.

Free-flow electrophoresis developed by Hannig (Hannig in Electrophoresis 1982, 3, 235-243) has a continuous buffer film flowing perpendicular to an electric field. On one side of the free-flow electrophoresis chamber, the protein sample is fed in at a defined position.

In the first separation step, two different methods of free-flow electrophoresis may be employed for the method proposed according to the invention: isoelectric focusing and isotachophoresis.

For isoelectric focusing, a pH gradient is generated with the aid of carrier ampholytes (Gerhard Weber and Petr Bocek in Electrophoresis 1998, 19, 1649-1653) which are applied, together with the buffer, between the two electrodes perpendicular to the direction of flow of the buffer film, which gradient fractionates the proteins in free flow owing to their charge (FFE-IEF). At the other end of the free-flow electrophoresis chamber, the individual fractions are collected by a series of tubes, for example, in the individual wells of a microtiter plate.

As an alternative to FFE-IEF, isotachophoresis may be used in the first separation step. In a discontinuous buffer system consisting of leading electrolyte and trailing electrolyte, a potential gradient is formed in the electric field. In the area of ions with low mobility, the field strength is higher than in the area of more mobile ions. Since migration of all ions has to occur at the same speed, pure zones of individual proteins are formed out of the protein sample mixture. At equilibrium, the ion having the highest mobility follows the leading ion of the leading electrolyte, the one having the lowest mobility migrates ahead of the trailing electrolyte, and the others migrate in between in order of decreasing mobility. In practice, an interval isotachophoresis is carried out (Gerhard Weber and Petr Bocek in Electrophoresis 1998, 19, 3090-3093). After applying the protein sample and the electrolyte to the free-flow electrophoresis chamber, high voltage is applied for 2 minutes to separate the proteins, and subsequently the separated fractions are conveyed in a voltage-free manner via a series of tubes into the individual wells of a microtiter plate.

For the first step proposed according to the invention for separating the proteins—both for FFE-IEF and for free-flow isotachophoresis—the electrophoresis apparatus “OCTOPUS” from Dr. Weber GmbH is used, for example.

In said electrophoresis apparatus, individual protein fractions (preferably 96) are obtained in microtiter plates after isoelectric focusing (FFE-IEF) or isotachophoresis. The proteins in said fractions may be linked both to a label, for example, a fluorophore such as Sypro® Orange, Sypro® Red or Sypro® Ruby and to at least one reactive fluorophore. Suitable derivatives for this purpose are, for example, N-hydroxysuccinimide esters (NHS esters) or isothiocyanates of fluorophores, which are coupled to free amino groups of the proteins. Particularly suitable are the N termini or lysines of the proteins or protein fractions. In addition, it is also easily possible to link appropriate derivatized fluorophores to carboxylate, thiol and hydroxyl groups of the proteins. The advantage which may be gained from using covalently bound fluorophores is primarily that it is possible in the subsequent separation step for a plurality of samples labeled with different dyes to be detected simultaneously in each capillary.

In the second separation step, covalently fluorescently labeled proteins can, for example, be separated with the aid of capillary electrophoresis. On the one hand, the one or more capillary tubes used may be filled with a polyacrylamide gel, on the other hand, however, the use of unloaded, i.e. empty capillary tubes, is also possible.

Detection follows, preferably using laser-induced fluorescence and, to improve the migration behavior of the proteins in the capillary electrophoresis, sodium dodecyl sulfate may be added to the separation buffer. Ideally, all wells in the microtiter plate are detected and quantified in parallel and separately in the same number of capillaries. A commercial apparatus, for example Mega-BACE from Amersham Pharmacia or another similarly designed apparatus, is used for DNA sequencing in a preferred and simple manner. An advantage compared to conventional 2D gel electrophoresis with subsequent noncovalent staining and image analysis for quantification is that the electropherograms obtained according to the method described here can readily be quantified using commercial software.

In one emboidment of the method proposed in accordance with the invention, it is possible to detect simultaneously a plurality of various labels, such as: fluorophores in each capillary, which can be used in accordance with the second fractionation step in the capillary electrophoresis. In a modification of said method, it is just as well possible to detect only one fluorophore or fluorescent substance. Therefore, a plurality of protein samples which have been labeled with different fluorophores can be mixed and separated simultaneously in a single capillary. This fact contributes in the second process step to parallelization, i.e. parallel treatment of a plurality of samples simultaneously. The plurality of samples analyzed in one run are preferably proteins from different cells or from cells of different developmental stages or from cells which were exposed to different external conditions (e.g. heat, cold, active substances, chemicals, etc.).

Fluorescence detection, which is to be categorized as substantially more sensitive, ensures a wide dynamic range and high sensitivity. It is furthermore possible, due to the high separation efficiency within capillary electrophoresis, to achieve a substantially better resolution of the protein samples or the protein samples of cellular origin in the second dimension, compared with the 2D PAGE methods. Owing to the substantially better automation possibility of the two methods, free-flow electrophoresis and capillary electrophoresis, a substantially higher turnover and therefore better statistical validation of the data will occur. After carrying out the method proposed according to the invention, a program sequence for evaluating the electropherograms has to be drawn up; furthermore, implementation of the method proposed according to the invention requires, for example, a free-flow electrophoresis apparatus (“Octopus” from Dr. Weber GmbH) and also, for example, a Mega-BACE sequencer from Amersham or a similar apparatus.

1. A method for fractionating and detecting proteins or protein samples of cellular origin, the proteins being contained in a separation buffer solution and the following process steps being performed:
the protein samples are split into individual fractions in a first separation step in accordance with free-flow electrophoresis or isoelectric focusing (IEF) or isotachophoresis and are linked to a label,
in a second separation step, the protein fractions are fractionated in one or more capillaries in accordance with capillary electrophoresis, and at least one label, linked to the protein fractions, is detected in said one capillary or said several capillaries.

2. A method as claimed in claim 1, which comprises linking, after the first separation step, all proteins in the protein fractions obtained to a reactive fluorophore.

3. A method as claimed in claim 2, which comprises coupling N-hydroxysuccinimide esters (NHS esters) or isothiocyanates of fluorophores to free amino groups of the proteins.

4. A method as claimed in claim 3, wherein the coupling sites are free amino groups such as the N termini or lysines of the proteins.

5. A method as claimed in claim 2, which comprises coupling iodoacetamido, maleimide, [acetylmercaptosuccinoyl]amino- (=SAMSA), pyridyldithiopropionamide (=PDP) or bromomethyl derivatives of fluorophores to free sulfhydryl groups of the proteins.

6. A method as claimed in claim 2, which comprises coupling the reactive fluorophores to carboxylate, thiol or hydroxyl groups of the proteins.

7. A method as claimed in claim 5, wherein the coupling sites are free sulfhydryl groups of the cysteines.

8. A method as claimed in claim 1, wherein, after the first separation step, all proteins in the protein fractions obtained are admixed with a fluorescent label.

9. A method as claimed in claim 8, wherein the labels are bound to the proteins adsorptively by van-der-Waals, ionic or hydrophobic interactions.

10. A method as claimed in claim 1, wherein the capillaries used in the second separation step contain a polyacrylamide gel.

11. A method as claimed in claim 1, wherein the capillaries used in the second separation step contain agarose.

12. A method as claimed in claim 1, wherein the capillaries used in the second separation step contain no gel.

13. A method as claimed in claim 1, wherein the capillaries used in the second separation step contain a synthetic polymer matrix.

14. A method as claimed in claim 1, wherein the detection in the second fractionation step is carried out using laser-induced fluorescence.

15. A method as claimed in claim 1, which comprises adding sodium dodecyl sulfate to the separation buffer containing the proteins during capillary electrophoresis.

16. A method as claimed in claim 1, which comprises carrying out parallel fractionation of the protein samples in the first separation step into preferably 96 different protein fractions, a microtiter plate being used whose number of wells corresponds to the number of separated protein fractions.

17. A method as claimed in claim 16, wherein the number of capillaries in the second separation step corresponds to the number or part of the number of protein fractions applied to the microtiter plate.
